(19) United States
(12) Patent Application Publication
(10) Pub. No.: US 2026/0173141 A1
(43) Pub. Date: Jun. 18, 2026

(54) ELR PPDU INDICATION METHOD AND DEVICE, AND STORAGE MEDIUM

(71) Applicant: RUIJIE NETWORKS CO., LTD., Fuzhou (CN)

(72) Inventor: Ke ZHONG, Fuzhou (CN)

(21) Appl. No.: 19/534,811

(22) Filed: Feb. 10, 2026

Related U.S. Application Data
(63) Continuation of application No. PCT/CN2025/116094, filed on Aug. 21, 2025.

(30) Foreign Application Priority Data
Aug. 21, 2024 (CN) 202411151962.7

(51) Int. Cl. H04W 74/0816; H04L 1/00

(52) U.S. Cl. CPC H04W 74/0816; H04L 1/0003

(57) ABSTRACT

An ELR PPDU indication method, a device, and a storage medium are provided. The method includes: transmitting ELR PPDU indication signaling to a target terminal device, where the ELR PPDU indication signaling is configured to indicate whether the target terminal device is to transmit and/or receive an ELR PPDU, and the ELR PPDU indication signaling is configured to indicate the target terminal device to enable or disable an ELR PPDU transmission and/or reception function, where the ELR PPDU indication signaling is carried in an MU PPDU frame for transmission.

### CROSS-REFERENCE TO RELATED APPLICATIONS

This application is a continuation of International Patent Application PCT/CN2025/116094 filed on Aug. 21, 2025, which claims priority to Chinese Patent Application No. 202411151962.7, filed with the China National Intellectual Property Administration on Aug. 21, 2024 and entitled “ELR PPDU INDICATION METHOD AND APPARATUS, DEVICE, AND STORAGE MEDIUM”, both of which are incorporated herein by reference in their entireties.

### TECHNICAL FIELD

This application relates to the field of communication, and more specifically, to an ELR PPDU indication method, a device, and a storage medium.

### BACKGROUND

In indoor and outdoor Internet of Things application scenarios such as wireless video doorbells, outdoor surveillance cameras, wireless garage door controllers, outdoor sprinkler controllers, wireless speakers, smart appliances, and security IoT devices, longer-distance, more efficient, and more compatible WI-FI (Wireless Fidelity, wireless local area network technology) solutions are needed.

In current WI-FI products, since the AP (Access Point, station device) typically has higher transmit power than the non-AP STA (non-AP Station, terminal device), the AP may have a transmission limitation problem, that is, there is an asymmetry in uplink and downlink coverage. For example, many people have the experience that even when the WI-FI signal strength shows one or two bars, the non-AP STA is unable to communicate with the AP. To address this problem, the industry uses ELR (English: Enhanced/Extended Long Range, Chinese: enhanced long-range) PPDU (Physical Layer Protocol Data Unit, physical layer protocol data unit) to achieve long-range enhancement of data communication for terminal devices.

### SUMMARY

Exemplary embodiments of this application provide an ELR PPDU indication method and apparatus, a device, and a storage medium.

According to a first aspect, an ELR PPDU indication method is provided, including:
transmitting ELR PPDU indication signaling to a target terminal device, where the ELR PPDU indication signaling is used to indicate whether the target terminal device is to transmit and/or receive an ELR PPDU.

According to a second aspect, an ELR PPDU indication method is provided, including:
receiving ELR PPDU indication signaling transmitted by a station device; and
determining, based on the ELR PPDU indication signaling, whether to transmit and/or receive an ELR PPDU.

According to a third aspect, an ELR PPDU indication apparatus is provided, including:
a signaling transmitting module, configured to transmit ELR PPDU indication signaling to a target terminal device, where the ELR PPDU indication signaling is used to indicate whether the target terminal device is to transmit and/or receive an ELR PPDU.

According to a fourth aspect, an ELR PPDU indication apparatus is provided, including:
a signaling receiving module, configured to receive ELR PPDU indication signaling transmitted by a station device; and
a determining module, configured to determine, based on the ELR PPDU indication signaling, whether to transmit and/or receive an ELR PPDU.

According to a fifth aspect, a station device is provided, including a processor and a memory, where the memory is configured to store a computer program, and the processor is configured to invoke and run the computer program stored in the memory to execute the method according to the first aspect or the implementations thereof.

According to a sixth aspect, a terminal device is provided, including a processor and a memory, where the memory is configured to store a computer program, and the processor is configured to invoke and run the computer program stored in the memory to execute the method according to the second aspect or the implementations thereof.

According to a seventh aspect, a chip is provided and configured to implement the method in any one of the first aspect and the second aspect or the implementations thereof. Specifically, the chip includes: a processor, configured to invoke and run a computer program from a memory, so that a device equipped with the chip executes the method according to any one of the first aspect and the second aspect or the implementations thereof.

According to an eighth aspect, a readable storage medium is provided and configured to store a computer program, where the computer program enables a computer to execute the method according to any one of the first aspect and the second aspect or the implementations thereof.

According to a ninth aspect, a communication device is provided, including: a processor and a memory, where the memory is configured to store a computer program, and the processor is configured to invoke and run the computer program stored in the memory to execute the method according to any one of the first aspect and the second aspect or the implementations thereof.

According to a tenth aspect, a communication system is provided, including a station device and a terminal device, where the station device is configured to execute the method according to any one of the first aspect or the implementations thereof, and the terminal device is configured to execute the method according to any one of the second aspect or the implementations thereof.

### BRIEF DESCRIPTION OF DRAWINGS

To describe the technical solutions in the embodiments of the present invention or in the prior art more clearly, the following briefly describes the accompanying drawings required for describing the embodiments or the prior art. Apparently, the accompanying drawings in the following description show some embodiments of the present invention, and those of ordinary skill in the art may derive other drawings from these accompanying drawings without creative efforts.

FIG. 1 is a schematic diagram of a communication system applicable to an embodiment of this application.

FIG. 2 is a first schematic diagram of interaction of an ELR PPDU indication method according to an embodiment of this application.

FIG. 3 is a schematic structural diagram of an MU PPDU frame format according to an embodiment of this application.

FIG. 4 is a schematic structural diagram of a frame format of a Special User Info field in a Trigger frame according to an embodiment of this application.

FIG. 5 is a schematic structural diagram of a frame format of a U-SIG Disregard And Validate subfield according to an embodiment of this application.

FIG. 6 is a first schematic block diagram of an ELR PPDU indication apparatus according to an embodiment of this application.

FIG. 7 is a second schematic block diagram of an ELR PPDU indication apparatus according to an embodiment of this application.

FIG. 8 is a schematic block diagram of a communication device according to an embodiment of this application.

FIG. 9 is a schematic block diagram of a chip according to an embodiment of this application.

FIG. 10 is a schematic block diagram of a communication system according to an embodiment of this application.

### DESCRIPTION OF EMBODIMENTS

The technical solutions in the embodiments of this application will be described below in conjunction with the accompanying drawings in the embodiments of this application. Apparently, the described embodiments are only some rather than all of the embodiments of this application. All other embodiments obtained by those of ordinary skill in the art based on the embodiments of this application without creative efforts shall fall within the protection scope of this application.

It should be noted that in this specification, the terms “include”, “comprise”, or any of their variants are intended to cover a non-exclusive inclusion, such that a process, method, article, or apparatus that includes a series of elements includes not only those elements but also other elements that are not expressly listed, or further includes elements inherent to such process, method, article, or apparatus. In addition, the terms “first”, “second”, and the like in the specification are used to distinguish between different objects but not describe a specific sequence.

It should be noted that in the embodiments of this application, “at least one” means one or multiple, “multiple” means two or more, and “at least two” means two or more. “At least one of the following” or similar expressions may refer to any combination of these items. For example, at least one of a, b, or c may mean: a, b, c, “a and b”, “a and c”, “b and c”, or “a and b and c”.

It should be noted that in the embodiments of this application, “and/or” indicates that the connected objects may represent three relationships. For example, “A and/or B” may indicate the following three cases: only A exists, only B exists, and both A and B exist. The character “/” generally indicates an “or” relationship between the contextually associated objects.

It should be understood that the “indication” mentioned in the embodiments of this application may be a direct indication or an indirect indication. For example, A indicating B may mean that A directly indicates B, for example, B may be obtained through A; it may also mean that A indirectly indicates B, for example, A indicates C, and B may be obtained through C, for example, B and C have an association relationship.

The technical solutions provided in the embodiments of this application may be applied to a wireless local area network (wireless local area network, WLAN) system, such as the Wi-Fi protocol. The Wi-Fi protocol may include but is not limited to 802.11 series protocols, such as 802.11a protocol, 802.11ax protocol, 802.11ac, 802.11b protocol, 802.11be, 802.11g protocol, 802.11n protocol, 802.11bn protocol, or next-generation protocols.

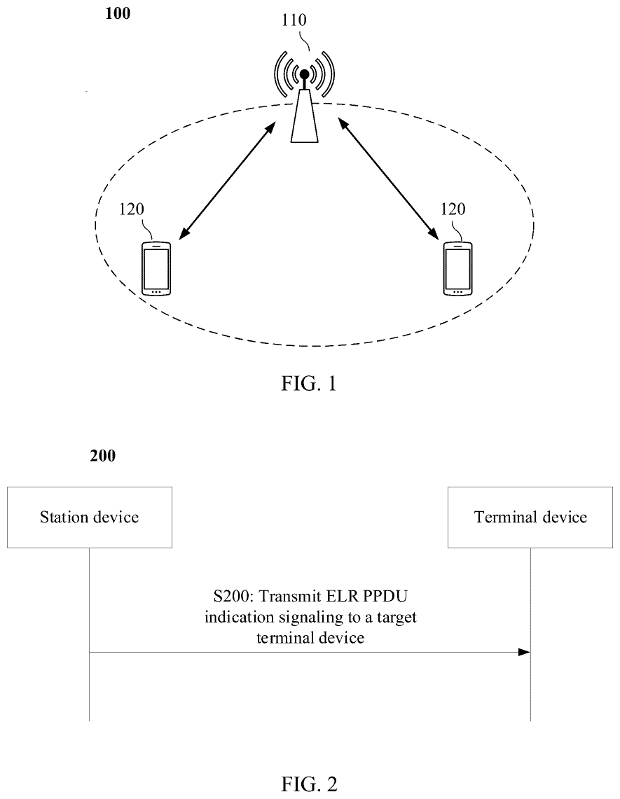

FIG. 1 is a schematic structural diagram of a communication system 100 applicable to an embodiment of this application. The communication system 100 may include a station device (Access Point, AP) 110 and a terminal device (STATION, Non-AP STA) 120. The terminal device 120 may access a network via the station device 110.

An access point may support communication or sensing based on the Wi-Fi protocol, for example, supporting communication or sensing based on 802.11a protocol, 802.11ax protocol, 802.11ac, 802.11b protocol, 802.11be, 802.11g protocol, 802.11n protocol, 802.11bn protocol, or next-generation protocols.

A station may support communication or sensing based on the Wi-Fi protocol, for example, supporting communication or sensing based on 802.11a protocol, 802.11ax protocol, 802.11ac, 802.11b protocol, 802.11be, 802.11g protocol, 802.11n protocol, 802.11bn protocol, or next-generation protocols.

The communication in the communication system 100 may be communication between an access point and a station, communication between stations, or communication between access points.

The access point serves as a bridge connecting a wired network and a wireless network, and its primary function is to connect various wireless network clients together and then connect the wireless network to Ethernet.

The terminal device is also referred to as a non-access point station (Non-AP STA), and the station device is also referred to as an access point or access point station (AP). In a sense, the access point is also a type of station.

In some scenarios, an access point and a station may be devices applied to vehicle to everything, Internet of things nodes, sensors, and the like in Internet of things (Internet of Things, IoT), smart cameras, smart remote controls, smart water and electricity meters, and the like in in smart home, and sensors in smart city.

In some scenarios, the access point may be a terminal device (such as a mobile phone) with a Wi-Fi chip or a network device (such as a router).

In this embodiment of this application, the station may be a mobile phone, a tablet computer, a computer, a virtual reality (Virtual Reality, VR) device, an augmented reality (Augmented Reality, AR) device, a wireless device in industrial control (industrial control), a set-top box, a wireless device in self driving (self driving), a vehicle-mounted communication device, a wireless device for remote medical (remote medical), a wireless device for a smart grid (smart grid), a wireless device for transportation safety (transportation safety), a wireless device for a smart city (smart city) or a wireless device for a smart home (smart home), a wireless communication chip, or the like, where the station supports the WLAN or Wi-Fi technologies.

It should be understood that FIG. 1 only illustrates one access point and two stations. Optionally, the communication system 100 may include multiple access points or another quantity of stations. This is not limited in this embodiment of this application.

Optionally, the communication system 100 may further include other devices such as a network controller, a gateway, and other network entities, which is not limited in this application.

To facilitate understanding of this embodiment of this application, the related technologies of this application are described.

Currently, devices supporting the Wi-Fi 5 (802.11ac) standard have their service coverage limited by the UL (Up Link, uplink) range. The existing solution is to use the 11b technology on the 2.4 GHz UL to achieve an increase of approximately 6 dB on the UL. However, the 11b technology released in 1999 is outdated and incompatible with channel coding, featuring poor performance, poor forward compatibility, and difficulty in management. Therefore, it is necessary to propose a new generation long-range solution that may integrate channel coding, OFDM/OFDMA, and MAC functions to achieve longer communication distance and higher data rate. For devices supporting the Wi-Fi 6 (802.11ax) standard, UORA (UL-OFDMA Random Access, random access mechanism) is used to achieve a power gain of approximately 10 dB, but its application is restricted in channels limited by DFS (Dynamic Frequency Selection, dynamic frequency selection) and PSD (Power Spectral Density, power spectral density). In addition, due to low time efficiency (delay caused by transmission failure due to collisions), UORA is not widely adopted in products on the market (almost invisible in products). For devices supporting Wi-Fi 7 (802.11be), small RU (Resource Unit, resource unit) ETH UL TB PPDU (EtherNet UP Line Trigger-Based Physical Layer Protocol Data Unit, Ethernet uplink trigger-based physical layer protocol data unit) is utilized to enable the STA to achieve longer-distance transmission by concentrating its power in a narrow bandwidth. However, since UL TB PPDU does not undergo preamble processing and only processes EHT-STF, EHT-LTF, and data, while the preamble of UL TB PPDU occupies at least 20 MHz, the AP is unable to receive the UL TB PPDU over such a long distance. For future devices supporting the Wi-Fi 8 (802.11bn) standard, to address the problem of link budget imbalance caused by the difference in uplink and downlink transmit power, it is necessary to define an ELR PPDU to extend the uplink coverage of the STAs (including uplink association request, sounding feedback, BA/ACK, and UL SU data), and improve the coexistence and throughput of 2.4 GHz uplink and downlink. The design objective of the ELR PPDU is to enhance the coverage at 1 Mbps by approximately 9-10 dB compared with that of 802.11g at 6 Mbps, and by approximately 3-4 dB compared with that of 802.11b at 1 Mbps. Under the above design guidance, the 1 Mbps ELR design may adopt a simple repetition scheme in the preamble, data field, and channel coding. Under the design guidelines, the ELR design supporting a rate of 1 Mbps may adopt a simple repetition scheme for the preamble, data field, and channel coding. With the above design, the UHR ELR may achieve a coverage improvement of 10 dB over 802.11g at 6 Mbps, and a coverage improvement of 4 dB over 802.11b at 1 Mbps. Since the uplink-downlink link margin imbalance exists in the 2.4 GHz, 5 GHZ, and 6 GHz frequency bands, the ELR PPDU needs to be enabled for all frequency bands in 802.11bn (such as the 2.4 GHz, 5 GHZ, and 6 GHz frequency bands).

However, configuring a terminal device to use ELR PPDUs all the time may lead to resource waste. For example, when a terminal device moves from a remote location to a position close to a station device, the communication requirement may be satisfied without enabling the ELR PPDUs. If the terminal device is configured to not use ELR PPDUs, a problem of limited long-distance communication will arise. For example, when a terminal device moves from the position close to a station device to a remote location and exceeds a certain range, a problem of poor communication signals will occur. Therefore, the existing technologies fail to adapt to the dynamic change requirements for terminal devices.

FIG. 2 is a schematic diagram of interaction of an ELR PPDU indication method of this application. It should be understood that although the various steps in the flowchart of FIG. 2 are shown in sequence according to the arrow indication, these steps are not necessarily executed in order indicated by the arrows. Unless explicitly stated in this specification, the execution of these steps is not subject to strict sequential limitations and may be executed in other orders. Moreover, at least some of the steps in FIG. 2 may include multiple sub-steps or multiple stages. These sub-steps or stages are not necessarily executed at the same time but may be executed at different times, and their execution order is not necessarily sequential but may be executed sequentially or alternately with other steps or at least some of the sub-steps or stages of other steps. The method 200 is applied to a station device and includes at least the following content.

S200: Transmit ELR PPDU indication signaling to a target terminal device, where the ELR PPDU indication signaling is used to indicate whether the target terminal device is to transmit and/or receive an ELR PPDU.

According to the ELR PPDU indication method provided in this embodiment of this application, the station device transmits, to the target terminal device, the ELR PPDU indication signaling that is used to indicate whether the target terminal device is to transmit and/or receive the ELR PPDU, so that the target terminal device in a dynamic state can activate or deactivate an ELR PPDU reception/transmission strategy in a timely manner, adapt to the dynamic change requirements for the terminal device, and avoid situations such as resource waste or poor communication signals.

It may be understood that one or more target terminal devices may be provided, and the station device may simultaneously indicate multiple target terminal devices to activate or deactivate the ELR PPDU reception/transmission strategy.

In some embodiments, when determining that signal energy/signal power with the target terminal device is less than a preset threshold, the station device may transmit, to the target terminal device, ELR PPDU indication signaling that is used to activate transmission and/or reception of the ELR PPDU; and when determining that the signal energy/signal power with the target terminal device is greater than or equal to the preset threshold, the station device may transmit, to the target terminal device, ELR PPDU indication signaling that is used to deactivate transmission and/or reception of the ELR PPDU.

In some embodiments, when determining that a communication bit error rate with the target terminal device is greater than a preset bit error rate, the station device may transmit, to the target terminal device, ELR PPDU indication signaling that is used to activate transmission and/or reception of the ELR PPDU; and when determining that the communication bit error rate with the target terminal device is less than or equal to the preset bit error rate, the station device may transmit, to the target terminal device, ELR PPDU indication signaling that is used to deactivate transmission and/or reception of the ELR PPDU.

In some embodiments, the ELR PPDU indication signaling is used to indicate the target terminal device to enable or disable an ELR PPDU transmission and/or reception function.

It may be understood that in this embodiment, the target terminal device is a device preconfigured with an ELR PPDU capability, so the station device only needs to transmit one piece of ELR PPDU indication signaling to the target terminal device so as to inform the target terminal device whether to enable or disable the ELR PPDU transmission and/or reception function. Herein, enabling the ELR PPDU transmission and/or reception function means that the target terminal device activates/starts the ELR PPDU transmission and/or reception function; and disabling the ELR PPDU transmission and/or reception function means that the target terminal device deactivates/stops the ELR PPDU transmission and/or reception function.

In some embodiments, the ELR PPDU indication signaling is used to indicate the target terminal device to transmit and/or receive the ELR PPDU based on configuration information in the ELR PPDU indication signaling.

It may be understood that in this embodiment, the target terminal device does not have or is not preconfigured with the ELR PPDU capability, and the station device needs to transmit, to the target terminal device, ELR PPDU indication signaling containing configuration information for activating the ELR PPDU, so that the target terminal device receives and/or transmits the ELR PPDU based on the configuration information.

Specifically, the configuration information includes one or more of an ELR PPDU transmission bandwidth, an uplink/downlink indication, the number of transmission streams, transmission duration, transmit power, transmission MCS, or a frame structure, which indicates the target terminal device to receive and/or transmit the ELR PPDU based on the transmission bandwidth, the uplink/downlink indication, the number of transmission streams, transmission duration, transmit power, transmission MCS, or the frame structure in the configuration information. It may be understood that the configuration information herein is all information applicable to the ELR PPDU. It is worth noting that when the content included in the above configuration information is actually used, all features may be used, or only one feature or some of the features may be used.

In some embodiments, the ELR PPDU indication signaling is carried in an MU PPDU frame for transmission.

This embodiment mainly indicates the target terminal device to receive or not receive ELR PPDU based on the ELR PPDU indication signaling, that is, this embodiment is applied to the downlink between AP and non-AP STA. It is worth noting that the ELR PPDU indication signaling is carried in the MU PPDU frame for transmission, which means that when the target terminal device receives the MU PPDU frame, if the ELR PPDU indication signaling carried in the frame indicates to enable the ELR PPDU transmission and/or reception function, the target terminal device receives the MU PPDU frame with the ELR PPDU reception capability or configuration. When transmitting data on the subsequent uplink, the target terminal device may also transmit the ELR PPDU.

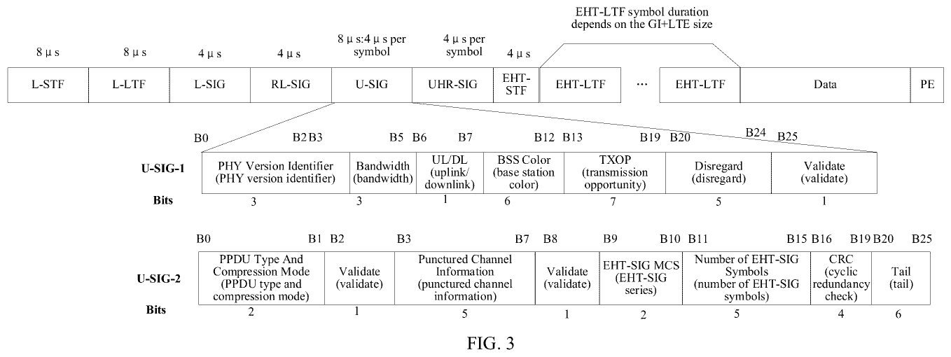

For the MU PPDU frame format shown in FIG. 3, the MU PPDU frame typically includes L-STF (Non-HT Short Training field, non-high-throughput short training), L-LTF (Non-HT Long Training field, non-high-throughput long training), L-SIG (Non-HT SIGNAL field, non-high-throughput signal), RL-SIG (Repeated Non-HT SIGNAL field, repeated non-high-throughput signal), U-SIG (Universal SIGNAL field, universal signal), EHT-SIG (EHT SIGNAL field, EHT signal), EHT-STF (EHT Short Training field, EHT short training signal), EHT-LTF (EHT Long Training field, EHT long training signal), Data (data), and PE (Packet Extension field). The ELR PPDU indication signaling in this embodiment is carried in a U-SIG field of the MU PPDU frame. The U-SIG field further includes a U-SIG-1 field and a U-SIG-2 field, where the U-SIG-1 field includes PHY Version Identifier (PHY Version Identifier, occupying 3 bits), Bandwidth (bandwidth, occupying 3 bits), UL/DL (uplink/downlink, occupying 1 bit), BSS Color (basic service set color, occupying 6 bits), TXOP (Transmission Opportunity, transmission opportunity, occupying 7 bits), Disregard (ignore, occupying 5 bits), and Validate (validate, occupying 1 bit); and the U-SIG-2 field includes PPDU Type And Compression Mode field (PPDU Type And Compression Mode field, occupying 2 bits), Validate (validate, occupying 1 bit), Punctured Channel Information (punctured channel information, occupying 5 bits), Validate (validate, occupying 1 bit), EHT-SIG MCS (EHT-SIG series, occupying 2 bits), Number of EHT-SIG Symbols (the number of EHT-SIG symbols, occupying 5 bits), CRC (cyclic redundancy check, occupying 4 bits), and Tail (tail, occupying 6 bits).

Specifically, in some embodiments, the ELR PPDU indication signaling is implemented by a value of the PHY Version Identifier (PHY Version Identifier) field in the U-SIG field of the MU PPDU frame.

Further, in some embodiments, when the ELR PPDU indication signaling is used to indicate the target terminal device to enable the ELR PPDU transmission and/or reception function, the value of the PHY Version Identifier field satisfies one of the following: PHY Version Identifier=2; PHY Version Identifier=3; PHY Version Identifier=4; PHY Version Identifier=5; PHY Version Identifier=6; or PHY Version Identifier=7. When the ELR PPDU indication signaling is used to indicate the target terminal device to disable the ELR PPDU transmission and/or reception function, the value of the PHY Version Identifier field is 0 or 1. That is, potential combinations indicating receiving/transmitting the ELR PPDU are shown in Table 1 below, and potential combinations indicating not receiving/transmitting the ELR PPDU are shown in Table 2 below. This embodiment enables the ELR PPDU indication for the target terminal device simply by configuring the value of the PHY Version Identifier field in the MU PPDU frame, with simple implementation and low overhead.

TABLE 1
Potential combinations for ELR PPDU indication based on value of PHY
Version Identifier field in MU PPDU frame

| Potential combinations for | Value of PHY Version Identifier |
|---|---|
| receiving/transmitting ELR PPDU | field |
| Potential combination 1 | PHY Version Identifier=2 |
| Potential combination 2 | PHY Version Identifier=3 |
| Potential combination 3 | PHY Version Identifier=4 |
| Potential combination 4 | PHY Version Identifier=5 |
| Potential combination 5 | PHY Version Identifier=6 |
| Potential combination 6 | PHY Version Identifier=7 |

TABLE 2
Potential combinations for ELR PPDU indication based on value of PHY
Version Identifier field in MU PPDU frame

| Potential combinations for not | |
|---|---|
| receiving/transmitting ELR PPDU | Value of PHY Version Identifier field |
| Potential combination 1 | PHY Version Identifier=0 or 1 |

In some embodiments, the ELR PPDU indication signaling is implemented by configuring the value of the PHY Version Identifier field and a value of at least one bit of a Disregard field in the MU PPDU frame.

As can be seen from the previous analysis of the MU PPDU frame, the Disregard field occupies 5 bits. To reduce overhead, the value of only one bit may be jointly used with the value of the PHY Version Identifier field to implement the ELR PPDU indication signaling. It may be understood that jointly using the PHY Version Identifier field and the Disregard field to implement the ELR PPDU indication signaling may improve the accuracy of the signaling and achieve the indication of the ELR PPDU with minimal changes to the existing standard.

Optionally, in some embodiments, values of multiple bits of the Disregard field may also be jointly used with the PHY Version Identifier field to implement the ELR PPDU indication signaling, such as 2 bits, 3 bits, 4 bits, . . . , or all 5 bits, and a value range of the Disregard field is 0-31.

Specifically, in some embodiments, as shown in Table 3 below, when the ELR PPDU indication signaling is used to indicate the target terminal device to enable the ELR PPDU transmission and/or reception function, the value of the PHY Version Identifier field is 1, and a value of a predetermined bit of the Disregard field is 1. As shown in Table 4 below, when the ELR PPDU indication signaling is used to indicate the target terminal device to disable the ELR PPDU transmission and/or reception function, the value of the PHY Version Identifier field is 1, and the value of the predetermined bit of the Disregard field is 0.

TABLE 3
Potential combinations for ELR PPDU indication based on values of
PHY Version Identifier field and Disregard field in MU PPDU frame

| Potential | Value of PHY | |
|---|---|---|
| combinations for | Version | Values of |
| receiving/transmitting | Identifier | Disregard bits |
| ELR PPDU | field | (B20-B24) |
| Potential combination | PHY Version | B20=1 (B21-B24 set to |
| 1 | Identifier=1 | any value) |
| Potential combination | PHY Version | B21=1 (B20 and B22-B24 |
| 2 | Identifier=1 | set to any value) |
| Potential combination | PHY Version | B22=1 (B20, B21, B23, and |
| 3 | Identifier=1 | B24 set to any value) |
| Potential combination | PHY Version | B23=1 (B20-B22 and B24 |
| 4 | Identifier=1 | set to any value) |
| Potential combination | PHY Version | B24=1 (B20-B23 set to any |
| 5 | Identifier=1 | value) |

TABLE 4
Potential combinations for ELR PPDU indication based on values of
PHY Version Identifier field and Disregard field in MU PPDU frame

| Potential | Value of PHY | |
|---|---|---|
| combinations for not | Version | |
| receiving/transmitting | Identifier | Values of |
| ELR PPDU | field | Disregard Bits |
| Potential combination | PHY Version | B20=0 (B21-B24 set to any |
| 1 | Identifier=1 | value) |
| Potential combination | PHY Version | B21=0 (B20 and B22-B24 set to |
| 2 | Identifier=1 | any value) |
| Potential combination | PHY Version | B22=0 (B20, B21, B23, and B24 |
| 3 | Identifier=1 | set to any value) |
| Potential combination | PHY Version | B23=0 (B20-B22 and B24 set to |
| 4 | Identifier=1 | any value) |
| Potential combination | PHY Version | B24=0 (B20-B23 set to any |
| 5 | Identifier=1 | value) |

In some embodiments, as shown in Table 5 below, when the ELR PPDU indication signaling is used to indicate the target terminal device to enable the ELR PPDU transmission and/or reception function, the value of the PHY Version Identifier field is 1, and the value of the predetermined bit of the Disregard field is 0. As shown in Table 6 below, when the ELR PPDU indication signaling is used to indicate the target terminal device to disable the ELR PPDU transmission and/or reception function, the value of the PHY Version Identifier field is 1, and the value of the predetermined bit of the Disregard field is 1.

TABLE 5
Potential combinations for ELR PPDU indication based on values of
PHY Version Identifier field and Disregard field in MU PPDU frame

| Potential | Value of PHY | |
|---|---|---|
| combinations for | Version | Values of |
| receiving/transmitting | Identifier | Disregard Bits |
| ELR PPDU | field | (B20-B24) |
| Potential combination | PHY Version | B20=0 (B21-B24 set to any |
| 1 | Identifier=1 | value) |
| Potential combination | PHY Version | B21=0 (B20 and B22-B24 set |
| 2 | Identifier=1 | to any value) |
| Potential combination | PHY Version | B22=0 (B20, B21, B23, and |
| 3 | Identifier=1 | B24 set to any value) |
| Potential combination | PHY Version | B23=0 (B20-B22 and B24 set |
| 4 | Identifier=1 | to any value) |
| Potential combination | PHY Version | B24=0 (B20-B23 set to any |
| 5 | Identifier=1 | value) |

TABLE 6
Potential combinations for ELR PPDU indication based on values of
PHY Version Identifier field and Disregard field in MU PPDU frame

| Potential | | |
|---|---|---|
| combinations for not | Value of PHY | |
| receiving/transmitting | Version Identifier | |
| ELR PPDU | field | Values of Disregard Bits |
| Potential combination | PHY Version | B20 = 1 |
| 1 | Identifier = 1 | (B21-B24 set to any value) |
| Potential combination | PHY Version | B21 = 1 (B20 and |
| 2 | Identifier = 1 | B22-B24 set to any value) |
| Potential combination | PHY Version | B22 = 1 (B20, B21, B23, and |
| 3 | Identifier = 1 | B24 set to any value) |
| Potential combination | PHY Version | B23 = 1 (B20-B22 and B24 set |
| 4 | Identifier = 1 | to any value) |
| Potential combination | PHY Version | B24 = 1 (B20-B23 set to any |
| 5 | Identifier = 1 | value) |

Further, the ELR PPDU indication signaling may also be implemented by configuring the value of the PHY Version Identifier field and values of all or part of bits of the Disregard field in the MU PPDU frame. That is, when the ELR PPDU indication signaling is used to indicate the target terminal device to enable the ELR PPDU transmission and/or reception function, the ELR PPDU indication signaling is implemented with the PHY Version Identifier field set to 1 and the Disregard field set to any value ranging from 0 to 31.

In some embodiments, the ELR PPDU indication signaling is also implemented by configuring a value of a PPDU Type And Compression Mode field and a value of a UL/DL field in the MU PPDU frame.

In addition to the fields in the foregoing embodiments, the PPDU Type And Compression Mode field and the UL/DL field may also be jointly used to implement the ELR PPDU indication signaling.

Optionally, as shown in Tables 7 and 8, when the ELR PPDU indication signaling is used to indicate the target terminal device to enable the ELR PPDU transmission and/or reception function, the value of the PPDU Type And Compression Mode field and the value of the UL/DL field satisfy one of the following: DL=0, PPDU Type And Compression Mode=3; or UL=1, PPDU Type And Compression Mode=2 or 3. All other values of the PPDU Type And Compression Mode field and the UL/DL field all indicate that the ELR PPDU indication signaling is used to indicate the target terminal device to disable the ELR PPDU.

TABLE 7
Potential combinations for ELR PPDU indication based on values of PPDU
Type And Compression Mode field and UL/DL field in MU PPDU frame

| | | Whether to receive/transmit ELR |
|---|---|---|
| U-SIG fields | | PPDU |
| UL/DL | PPDU Type And | No |
| | Compression Mode | |
| 0 (DL) | 0 | No |
| | 1 | No |
| | 2 | No |
| | 3 | Yes |

TABLE 8
Potential combinations for ELR PPDU indication based on values of PPDU
Type And Compression Mode field and UL/DL field in MU PPDU frame

| | | Whether to receive/transmit ELR |
|---|---|---|
| U-SIG fields | | PPDU |
| UL/DL | PPDU Type And | No |
| | Compression Mode | |
| 1 (UL) | 0 | No |
| | 1 | No |
| | 2 or 3 | Yes |

In some embodiments, the ELR PPDU indication signaling is implemented by configuring a modulation scheme of at least one OFDM symbol in the U-SIG field. Optionally, the ELR PPDU indication signaling is implemented by configuring a modulation scheme of one OFDM symbol in the U-SIG field, which may minimize interference to OFDM symbol encoding. Further, when the ELR PPDU indication signaling is used to indicate the target terminal device to enable the ELR PPDU transmission and/or reception function, a modulation scheme of the second OFDM symbol in the U-SIG field is QBPSK (Quadrature Binary Phase Shift Keying, quadrature binary phase shift keying). It may be understood that if the modulation scheme of the second OFDM symbol is not QBPSK, it means that the ELR PPDU indication signaling is used to indicate the target terminal device to disable the ELR PPDU transmission and/or reception function.

In some embodiments, the ELR PPDU indication signaling is implemented by configuring the value of the PHY Version Identifier field in the U-SIG field and a value of a Disregard field in a UHR-SIG field in the MU PPDU frame.

In some embodiments, when the ELR PPDU indication signaling is used to indicate the target terminal device to enable the ELR PPDU transmission and/or reception function, the PHY Version Identifier field of the U-SIG field is 1, and a value of a predetermined bit of the Disregard field in the UHR-SIG field is 0 or 1; or the PHY Version Identifier field of the U-SIG field is 1, and the Disregard field in the UHR-SIG field is any value in a predetermined range starting from 0. For example, the predetermined range is 0-31.

It is worth noting that the UHR-SIG (Ultra-High Reliability-SIGNAL, ultra-high reliability signal) field herein is not the same as the U-SIG (Universal SIGNAL, universal signal) field, and values of different fields are jointly used to implement an ELR PPDU indication. UHR-SIG is the name defined in Wi-Fi 8 (802.11be), which is derived based on EHT-SIG in Wi-Fi 7 (802.11ax) and inherits the relevant content in EHT-SIG.

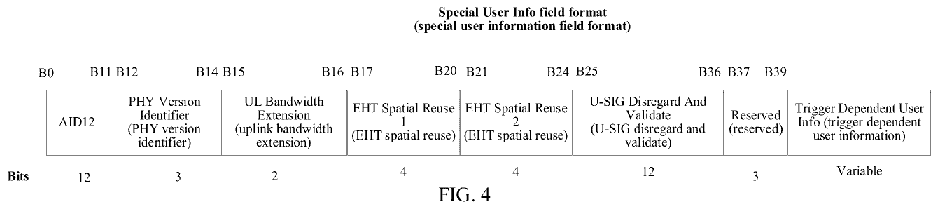

In some embodiments, the ELR PPDU indication signaling is carried in a Trigger frame for transmission. In some embodiments, the ELR PPDU indication signaling is carried in a Special User Info field in the Trigger frame for transmission. A format of the Special User Info field in the Trigger frame is shown in FIG. 4 and includes AID12 (occupying 12 bits), PHY Version Identifier (PHY Version Identifier, occupying 3 bits), UL Bandwidth Extension (uplink bandwidth extension, occupying 2 bits), EHT Spatial Reuse 1 (first EHT spatial reuse, occupying 4 bits), EHT Spatial Reuse 2 (second EHT spatial reuse, occupying 4 bits), U-SIG Disregard And Validate (U-SIG ignore and validate, occupying 12 bits), Reserved (reserved, occupying 3 bits), and Trigger Dependent User Info (trigger dependent user information, random variable).

This embodiment mainly indicates the target terminal device to transmit or not transmit the ELR PPDU based on the ELR PPDU indication signaling, that is, this embodiment is applied to the uplink between AP and non-AP STA. It is worth noting that the ELR PPDU indication signaling is carried in the Trigger frame for transmission, which means that when the target terminal device receives the Trigger frame, if the ELR PPDU indication signaling carried in the Trigger frame indicates to enable the ELR PPDU transmission and/or reception function, the target terminal device transmits a TB PPDU frame with the ELR PPDU capability or configuration when transmitting the subsequent TB PPDU frame.

In some embodiments, the ELR PPDU indication signaling is implemented by configuring a value of a PHY Version Identifier (PHY Version Identifier) field in the Special User Info field (special user information field) of the Trigger frame.

Optionally, in some embodiments, when the ELR PPDU indication signaling is used to indicate the target terminal device to enable the ELR PPDU transmission and/or reception function, as shown in Table 9 below, the value of the PHY Version Identifier field satisfies one of the following: PHY Version Identifier=2; PHY Version Identifier=3; PHY Version Identifier=4; PHY Version Identifier=5; PHY Version Identifier=6; or PHY Version Identifier=7. When the ELR PPDU indication signaling is used to indicate the target terminal device to disable the ELR PPDU transmission and/or reception function, as shown in Table 10 below, the value of the PHY Version Identifier field is 0 or 1. This embodiment enables the ELR PPDU indication for the target terminal device simply by configuring the value of the PHY Version Identifier field in the Trigger frame, with simple implementation and low overhead.

TABLE 9
Potential combinations for ELR PPDU indication based on value of PHY
Version Identifier field in Trigger frame

| Potential combinations for | Value of PHY Version Identifier |
|---|---|
| receiving/transmitting ELR PPDU | field |
| Potential combination 1 | PHY Version Identifier = 2 |
| Potential combination 2 | PHY Version Identifier = 3 |
| Potential combination 3 | PHY Version Identifier = 4 |
| Potential combination 4 | PHY Version Identifier = 5 |
| Potential combination 5 | PHY Version Identifier = 6 |
| Potential combination 6 | PHY Version Identifier = 7 |

TABLE 10
Potential combinations for ELR PPDU indication based on value of
PHY Version Identifier field in Trigger frame

| Potential combinations for not | |
|---|---|
| receiving/transmitting ELR PPDU | Value of PHY Version Identifier field |
| Potential combination 1 | PHY Version Identifier = 0 or 1 |

In some embodiments, the ELR PPDU indication signaling is implemented by configuring the value of the PHY Version Identifier field and a value of at least one bit of U-SIG Disregard and Validate in the Trigger frame.

As can be seen from the previous analysis of the Trigger frame, the U-SIG Disregard and Validate occupies 12 bits. To reduce overhead, a value of only one bit may be jointly used with the value of the PHY Version Identifier field to implement the ELR PPDU indication signaling. It may be understood that jointly using the PHY Version Identifier field and the U-SIG Disregard and Validate to implement the ELR PPDU indication signaling may improve the accuracy of the signaling and achieve the indication of the ELR PPDU with minimal changes to the existing standard.

Optionally, in some embodiments, values of multiple bits of the U-SIG Disregard and Validate may also be jointly used with the PHY Version Identifier field to implement the ELR PPDU indication signaling, such as 2 bits, 3 bits, 4 bits, . . . , or all 12 bits, and a value range of the U-SIG Disregard and Validate is 0-4095 (such as including 1 bit of Validate in U-SIG-2).

In some embodiments, as shown in Table 11 below, when the ELR PPDU indication signaling is used to indicate the target terminal device to enable the ELR PPDU transmission and/or reception function, the value of the PHY Version Identifier field is 1, and a value of a predetermined bit of the U-SIG Disregard and Validate is 1. As shown in Table 12 below, when the ELR PPDU indication signaling is used to indicate the target terminal device to disable the ELR PPDU transmission and/or reception function, the value of the PHY Version Identifier field is 1, and the value of the predetermined bit of the U-SIG Disregard and Validate is 0.

TABLE 11
Potential combinations for ELR PPDU indication based on values of
PHY Version Identifier field and U-SIG Disregard and
Validate in Trigger frame

| Potential | | |
|---|---|---|
| combinations for | Value of PHY | |
| receiving/ | Version | |
| transmitting | Identifier | Value of U-SIG Disregard and |
| ELR PPDU | field | Validate (B0-B11) |
| Potential | PHY Version | B0 = 1 (other bits set to any number) |
| combination 1 | Identifier = 1 | |
| Potential | PHY Version | B1 = 1 (other bits set to any number) |
| combination 2 | Identifier = 1 | |
| Potential | PHY Version | B2 = 1 (other bits set to any number) |
| combination 3 | Identifier = 1 | |
| Potential | PHY Version | B3 = 1 (other bits set to any number) |
| combination 4 | Identifier = 1 | |
| Potential | PHY Version | B4 = 1 (other bits set to any number) |
| combination 5 | Identifier = 1 | |
| Potential | PHY Version | B5 = 1 (other bits set to any number) |
| combination 6 | Identifier = 1 | |
| Potential | PHY Version | B7 = 1 (other bits set to any number) |
| combination 7 | Identifier = 1 | |
| Potential | PHY Version | B8 = 1 (other bits set to any number) |
| combination 8 | Identifier = 1 | |
| Potential | PHY Version | B9 = 1 (other bits set to any number) |
| combination 9 | Identifier = 1 | |
| Potential | PHY Version | B10 = 1 (other bits set to any number) |
| combination 10 | Identifier = 1 | |
| Potential | PHY Version | B11 = 1 (other bits set to any number) |
| combination 11 | Identifier = 1 | |

TABLE 12
Potential combinations for ELR PPDU indication based on values of PHY
Version Identifier field and U-SIG Disregard and Validate in Trigger frame

| Potential | | |
|---|---|---|
| combinations for not | Value of PHY | |
| receiving/transmitting | Version Identifier | Value of U-SIG Disregard and |
| ELR PPDU | field | Validate (B0-B11) |
| Potential combination | PHY Version | B0 = 0 (other bits set to any |
| 1 | Identifier = 1 | number) |
| Potential combination | PHY Version | B1 = 0 (other bits set to any |
| 2 | Identifier = 1 | number) |
| Potential combination | PHY Version | B2 = 0 (other bits set to any |
| 3 | Identifier = 1 | number) |
| Potential combination | PHY Version | B3 = 0 (other bits set to any |
| 4 | Identifier = 1 | number) |
| Potential combination | PHY Version | B4 = 0 (other bits set to any |
| 5 | Identifier = 1 | number) |
| Potential combination | PHY Version | B5 = 0 (other bits set to any |
| 6 | Identifier = 1 | number) |
| Potential combination | PHY Version | B7 = 0 (other bits set to any |
| 7 | Identifier = 1 | number) |
| Potential combination | PHY Version | B8 = 0 (other bits set to any |
| 8 | Identifier = 1 | number) |
| Potential combination | PHY Version | B9 = 0 (other bits set to any |
| 9 | Identifier = 1 | number) |
| Potential combination | PHY Version | B10 = 0 (other bits set to any |
| 10 | Identifier = 1 | number) |
| Potential combination | PHY Version | B11 = 0 (other bits set to any |
| 11 | Identifier = 1 | number) |

In some embodiments, as shown in Table 13, when the ELR PPDU indication signaling is used to indicate the target terminal device to enable the ELR PPDU transmission and/or reception function, the value of the PHY Version Identifier field is 1, and the value of the predetermined bit of the U-SIG Disregard and Validate is 0. As shown in Table 14, when the ELR PPDU indication signaling is used to indicate the target terminal device to disable the ELR PPDU transmission and/or reception function, the value of the PHY Version Identifier field is 1, and the value of the predetermined bit of the U-SIG Disregard and Validate is 1.

TABLE 13
Potential combinations for ELR PPDU indication based on values of PHY
Version Identifier field and U-SIG Disregard and Validate in Trigger frame

| Potential | | |
|---|---|---|
| combinations for | Value of PHY | |
| receiving/transmitting | Version Identifier | Value of U-SIG Disregard and |
| ELR PPDU | field | Validate (B0-B11) |
| Potential combination | PHY Version | B0 = 0 (other bits set to any |
| 1 | Identifier = 1 | number) |
| Potential combination | PHY Version | B1 = 0 (other bits set to any |
| 2 | Identifier = 1 | number) |
| Potential combination | PHY Version | B2 = 0 (other bits set to any |
| 3 | Identifier = 1 | number) |
| Potential combination | PHY Version | B3 = 0 (other bits set to any |
| 4 | Identifier = 1 | number) |
| Potential combination | PHY Version | B4 = 0 (other bits set to any |
| 5 | Identifier = 1 | number) |
| Potential combination | PHY Version | B5 = 0 (other bits set to any |
| 6 | Identifier = 1 | number) |
| Potential combination | PHY Version | B7 = 0 (other bits set to any |
| 7 | Identifier = 1 | number) |
| Potential combination | PHY Version | B8 = 0 (other bits set to any |
| 8 | Identifier = 1 | number) |
| Potential combination | PHY Version | B9 = 0 (other bits set to any |
| 9 | Identifier = 1 | number) |
| Potential combination | PHY Version | B10 = 0 (other bits set to any |
| 10 | Identifier = 1 | number) |
| Potential combination | PHY Version | B11 = 0 (other bits set to any |
| 11 | Identifier = 1 | number) |

TABLE 14
Potential combinations for ELR PPDU indication based on values of PHY
Version Identifier field and U-SIG Disregard and Validate in Trigger frame

| Potential | | |
|---|---|---|
| combinations for not | Value of PHY | |
| receiving/transmitting | Version Identifier | Value of U-SIG Disregard and |
| ELR PPDU | field | Validate (B0-B11) |
| Potential combination | PHY Version | B0 = 0 (other bits set to any |
| 1 | Identifier = 1 | number) |
| Potential combination | PHY Version | B1 = 0 (other bits set to any |
| 2 | Identifier = 1 | number) |
| Potential combination | PHY Version | B2 = 0 (other bits set to any |
| 3 | Identifier = 1 | number) |
| Potential combination | PHY Version | B3 = 0 (other bits set to any |
| 4 | Identifier = 1 | number) |
| Potential combination | PHY Version | B4 = 0 (other bits set to any |
| 5 | Identifier = 1 | number) |
| Potential combination | PHY Version | B5 = 0 (other bits set to any |
| 6 | Identifier = 1 | number) |
| Potential combination | PHY Version | B7 = 0 (other bits set to any |
| 7 | Identifier = 1 | number) |
| Potential combination | PHY Version | B8 = 0 (other bits set to any |
| 8 | Identifier = 1 | number) |
| Potential combination | PHY Version | B9 = 0 (other bits set to any |
| 9 | Identifier = 1 | number) |
| Potential combination | PHY Version | B10 = 0 (other bits set to any |
| 10 | Identifier = 1 | number) |
| Potential combination | PHY Version | B11 = 0 (other bits set to any |
| 11 | Identifier = 1 | number) |

Further, in some embodiments, to enhance the accuracy of the ELR PPDU indication, the ELR PPDU indication signaling is implemented by configuring the value of the PHY Version Identifier field and values of all or part of bits of Disregard in U-SIG-1 or Disregard in U-SIG-2 in the Trigger frame.

Specifically, when the ELR PPDU indication signaling is used to indicate the target terminal device to enable the ELR PPDU transmission and/or reception function, the value of the PHY Version Identifier field and the value of the Disregard in the U-SIG-1 or the Disregard in the U-SIG-2 satisfy one of the following: PHY Version Identifier=1, the value of the Disregard in the U-SIG-1 is any value ranging from 0 to 63; or PHY Version Identifier=1, the value of the Disregard in the U-SIG-2 is any value ranging from 0 to 31.

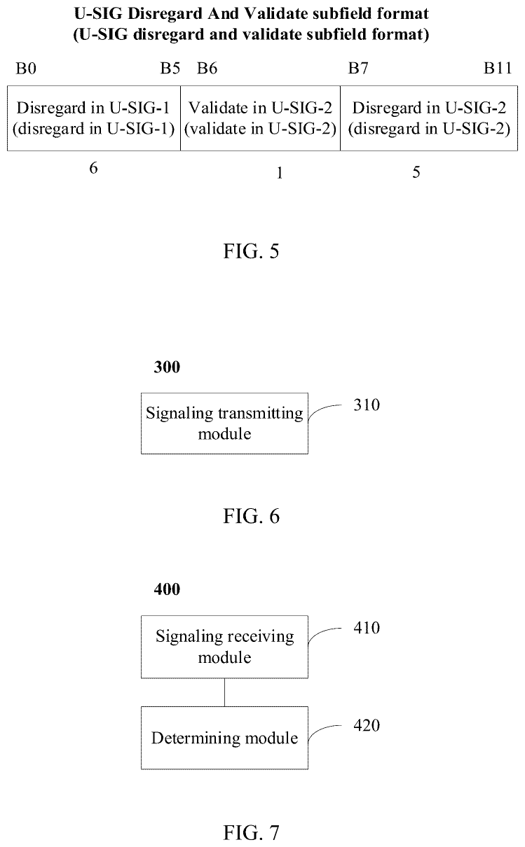

Referring to FIG. 5, the U-SIG Disregard and Validate field further includes Disregard in U-SIG-1 (ignore in U-SIG-1, occupying 6 bits), Validate in U-SIG-2 (validate in U-SIG-2, occupying 1 bit), and Disregard in U-SIG-2 (ignore in U-SIG-2, occupying 5 bits). Since the Disregard in the U-SIG-1 occupies 6 bits, its value may be any value ranging from 0 to 63, and the Disregard in the U-SIG-2 occupies 5 bits, its value may be any value ranging from 0 to 31, the value of the PHY Version Identifier field and the values of all or part of the bits of the Disregard in the U-SIG-1 or the Disregard in the U-SIG-2 may also be used to implement the ELR PPDU indication signaling.

In some embodiments, the ELR PPDU indication signaling is implemented by configuring the value of the PHY Version Identifier field and the value of at least one bit of Reserved in the Trigger frame.

In addition to using the foregoing fields in the Trigger frame to implement the ELR PPDU indication, the value of the PHY Version Identifier field in the Trigger frame and the value of the Reserved may also be used to implement the ELR PPDU indication. The Reserved is a reserved field, and using this field to implement the ELR PPDU indication causes no additional overhead to the Trigger frame.

In some embodiments, referring to Table 15, when the ELR PPDU indication signaling is used to indicate the target terminal device to enable the ELR PPDU transmission and/or reception function, the value of the PHY Version Identifier field is 1, and a value of a predetermined bit of the Reserved is 1. Referring to Table 16, when the ELR PPDU indication signaling is used to indicate the target terminal device to disable the ELR PPDU transmission and/or reception function, the value of the PHY Version Identifier field is 1, and the value of the predetermined bit of the Reserved is 0.

TABLE 15
Potential combinations for ELR PPDU indication based on values of
PHY Version Identifier field and Reserved in Trigger frame

| Potential | | |
|---|---|---|
| combinations for | Value of PHY | |
| receiving/transmitting | Version Identifier | |
| ELR PPDU | field | Value of Reserved (B37-B39) |
| Potential | PHY Version | B37 = 1 |
| combination 1 | Identifier = 1 | (other bits set to any number) |
| Potential | PHY Version | B38 = 1 |
| combination 2 | Identifier = 1 | (other bits set to any number) |
| Potential | PHY Version | B39 = 1 |
| combination 3 | Identifier = 1 | (other bits set to any number) |

TABLE 16
Potential combinations for ELR PPDU indication based on values of
PHY Version Identifier field and Reserved in Trigger frame

| Potential | | |
|---|---|---|
| combinations for not | Value of PHY | |
| receiving/transmitting | Version | |
| ELR PPDU | Identifier field | Value of Reserved (B37-B39) |
| Potential combination | PHY Version | B37 = 0 |
| 1 | Identifier = 1 | (other bits set to any number) |
| Potential combination | PHY Version | B38 = 0 |
| 2 | Identifier = 1 | (other bits set to any number) |
| Potential combination | PHY Version | B39 = 0 |
| 3 | Identifier = 1 | (other bits set to any number) |

In some embodiments, referring to Table 17, when the ELR PPDU indication signaling is used to indicate the target terminal device to enable the ELR PPDU transmission and/or reception function, the value of the PHY Version Identifier field is 1, and the value of the predetermined bit of the Reserved is 0. Referring to Table 18, when the ELR PPDU indication signaling is used to indicate the target terminal device to disable the ELR PPDU transmission and/or reception function, the value of the PHY Version Identifier field is 1, and the value of the predetermined bit of the Reserved is 1.

TABLE 17
Potential combinations for ELR PPDU indication based on values of
PHY Version Identifier field and Reserved in Trigger frame

| Potential | | |
|---|---|---|
| combinations for | Value of PHY | |
| receiving/transmitting | Version | Value of Reserved |
| ELR PPDU | Identifier field | (B37-B39) |
| Potential | PHY Version | B37 = 0 (other bits set to any |
| combination 1 | Identifier = 1 | number) |
| Potential | PHY Version | B38 = 0 (other bits set to any |
| combination 2 | Identifier = 1 | number) |
| Potential | PHY Version | B39 = 0 (other bits set to any |
| combination 3 | Identifier = 1 | number) |

TABLE 18
Potential combinations for ELR PPDU indication based on values of
PHY Version Identifier field and Reserved in Trigger frame

| Potential | | |
|---|---|---|
| combinations for not | | |
| receiving/transmitting | Value of PHY Version | Value of Reserved |
| ELR PPDU | Identifier field | (B37-B39) |
| Potential combination | PHY Version | B37 = 1 (other bits set to |
| 1 | Identifier = 1 | any number) |
| Potential combination | PHY Version | B38 = 1 (other bits set to |
| 2 | Identifier = 1 | any number) |
| Potential combination | PHY Version | B39 = 1 (other bits set to |
| 3 | Identifier = 1 | any number) |

It may be understood that in some embodiments, the value of the PHY Version Identifier field may also be jointly used with values of multiple bits of the Reserved field to implement the ELR PPDU indication signaling, such as 2 bits and 3 bits. A value range of the Reserved is 0-7.

In some embodiments, the ELR PPDU indication signaling is implemented by configuring a value of a PPDU Type And Compression Mode field in the Trigger frame (in FIG. 4, the PPDU Type And Compression Mode field of the Trigger frame is not shown, which is located in the U-SIG field of the Trigger frame, referring to the corresponding structure of the MU PPDU frame) and a value of a UL/DL field (in FIG. 4, the UL/DL field of the Trigger frame is not shown, which is located in the U-SIG field of the Trigger frame, referring to the corresponding structure of the MU PPDU frame).

Optionally, in some embodiments, as shown in Tables 19 and 20, when the ELR PPDU indication signaling is used to indicate the target terminal device to enable the ELR PPDU transmission and/or reception function, the value of the PPDU Type And Compression Mode field and the value of the UL/DL field satisfy one of the following: DL=0, PPDU Type And Compression Mode=3; or UL=1, PPDU Type And Compression Mode=2 or 3.

It may be understood that other values of the PPDU Type And Compression Mode field and the UL/DL field all indicate that the ELR PPDU indication signaling is used to indicate the target terminal device to disable the ELR PPDU.

TABLE 19
Potential combinations for ELR PPDU indication based on values of PPDU
Type And Compression Mode field and UL/DL field in Trigger frame

| U-SIG fields | | Whether to receive/transmit ELR PPDU |
|---|---|---|
| UL/DL | PPDU Type And | No |
| | Compression Mode | |
| 0 (DL) | 0 | No |
| | 1 | No |
| | 2 | No |
| | 3 | Yes |

TABLE 20
Potential combinations for ELR PPDU indication based on values of PPDU
Type And Compression Mode field and UL/DL field in Trigger frame

| U-SIG fields | | Whether to receive/transmit ELR PPDU |
|---|---|---|
| UL/DL | PPDU Type And | No |
| | Compression Mode | |
| 1 (UL) | 0 | No |
| | 1 | No |
| | 2 or 3 | Yes |

In some embodiments, the ELR PPDU indication signaling is implemented by configuring a modulation scheme of at least one OFDM symbol in a U-SIG field of the Trigger frame. Optionally, the ELR PPDU indication signaling is implemented by configuring a modulation scheme of one OFDM symbol in the U-SIG field, which may minimize interference to OFDM symbol encoding. Further, when the ELR PPDU indication signaling is used to indicate the target terminal device to enable the ELR PPDU transmission and/or reception function, a modulation scheme of the second OFDM symbol in the U-SIG field is QBPSK (Quadrature Binary Phase Shift Keying). It may be understood that if the modulation scheme of the second OFDM symbol is not QBPSK, it means that the ELR PPDU indication signaling is used to indicate the target terminal device to disable the ELR PPDU transmission and/or reception function.

It is worth noting that the MU PPDU in the foregoing embodiments may be UHR MU PPDU or EHT MU PPDU. The TB PPDU in the foregoing embodiments may be UHR TB PPDU or EHT TB PPDU. UHR MU PPDU and UHR TB PPDU are the names of MU PPDU and TB PPDU in 802.11bn. EHT MU PPDU and EHT TB PPDU are the names of MU PPDU and TB PPDU in 802.11be. UHR MU PPDU is derived from EHT MU PPDU, and UHR TB PPDU is derived from EHT TB PPDU.

With the ELR PPDU indication method provided in this embodiment, the station device transmits, to the target terminal device, the ELR PPDU indication signaling that is used to indicate whether the target terminal device is to transmit and/or receive the ELR PPDU, so that the target terminal device in a dynamic state can activate or deactivate the ELR PPDU reception/transmission strategy in a timely manner to adapt to the dynamic change requirements for the terminal device. This method not only fills the gap in the current IEEE standard for the ELR PPDU indication, but also effectively mitigates the issues of resource waste or poor communication signal.

An embodiment of this application further provides an ELR PPDU indication method applied to a terminal device, where the method includes the following content:
receiving an ELR PPDU indication signaling transmitted by a station device; and
determining, based on the ELR PPDU indication signaling, whether to transmit and/or receive an ELR PPDU.

Through the ELR PPDU indication method provided in this embodiment, the station device transmits, to the target terminal device, the ELR PPDU indication signaling that is used to indicate whether the target terminal device is to transmit and/or receive the ELR PPDU, so that the target terminal device in a dynamic state can activate or deactivate an ELR PPDU reception/transmission strategy in a timely manner to adapt to the dynamic change requirements for the terminal device. This method not only fills the gap in the current IEEE standard for an ELR PPDU indication, but also effectively mitigates the issues of resource waste or poor communication signal.

In some embodiments, the determining, based on the ELR PPDU indication signaling, whether to transmit and/or receive an ELR PPDU includes:
determining, based on the ELR PPDU indication signaling, to enable or disable an ELR PPDU transmission and/or reception function.

In some embodiments, the determining, based on the ELR PPDU indication signaling, whether to transmit and/or receive an ELR PPDU includes:
transmitting and/or receiving the ELR PPDU based on configuration information in the ELR PPDU indication signaling.

In some embodiments, the ELR PPDU indication signaling is carried in an MU PPDU frame for transmission.

In some embodiments, the ELR PPDU indication signaling is implemented by at least one of the following manners:
configuring a value of a PHY Version Identifier field in the MU PPDU frame;
configuring a value of a PHY Version Identifier field and a value of at least one bit of a Disregard field in the MU PPDU frame; or
configuring a value of a PPDU Type And Compression Mode field and a value of a UL/DL field in the MU PPDU frame.

In some embodiments, the ELR PPDU indication signaling is carried in a Trigger frame for transmission.

The ELR PPDU indication signaling is implemented by at least one of the following manners:
configuring a value of a PHY Version Identifier field in the Trigger frame;
configuring a value of a PHY Version Identifier field and a value of at least one bit of U-SIG Disregard and Validate in the Trigger frame;
configuring a value of a PHY Version Identifier field and values of all or part of bits of Disregard in U-SIG-1 or Disregard in U-SIG-2 in the Trigger frame;
configuring a value of a PHY Version Identifier field and a value of at least one bit of Reserved in the Trigger frame; or
configuring a value of a PPDU Type And Compression Mode field and a value of a UL/DL field in the Trigger frame.

The ELR PPDU indication method applied to the terminal device can achieve all technical effects of a method applied to a station device side. To avoid repetition, details are not described herein again.

The method embodiments of this application are described in detail above in conjunction with FIGS. 3 to 10. The apparatus embodiments of this application are described in detail below in conjunction with FIGS. 11 to 15. It should be understood that the apparatus embodiments correspond to the method embodiments, and similar descriptions may refer to the method embodiments.

FIG. 6 is a schematic block diagram of an ELR PPDU indication apparatus 300 according to an embodiment of this application. The ELR PPDU indication apparatus 300 may be a station device or a component in the station device, such as a chip, a circuit, or a module.

As shown in FIG. 6, the ELR PPDU indication apparatus 300 includes: a signaling transmitting module 310, configured to transmit ELR PPDU indication signaling to a target terminal device, where the ELR PPDU indication signaling is used to indicate whether the target terminal device is to transmit and/or receive an ELR PPDU.

Through the ELR PPDU indication apparatus provided in this embodiment, the station device transmits, to the target terminal device, the ELR PPDU indication signaling that is used to indicate whether the target terminal device is to transmit and/or receive the ELR PPDU, so that the target terminal device in a dynamic state can activate or deactivate an ELR PPDU reception/transmission strategy in a timely manner to adapt to the dynamic change requirements for the terminal device. This method not only fills the gap in the current IEEE standard for an ELR PPDU indication, but also effectively mitigates the issues of resource waste or poor communication signal.

It should be understood that the apparatus 300 provided in this embodiment of this application may correspond to a multi-link station device in the method embodiments of this application, and the above and other operations and/or functions of various units in the apparatus 300 are respectively intended to implement the corresponding flows of the station device in the embodiments in FIGS. 3 to 9. For brevity, details are not described herein again.

FIG. 7 is a schematic block diagram of another ELR PPDU indication apparatus 400 according to an embodiment of this application. The ELR PPDU indication apparatus 400 may be a terminal device or a component in the terminal device, such as a chip, a circuit, or a module. The ELR PPDU indication apparatus 400 in FIG. 7 includes: a signaling receiving module 410, configured to receive ELR PPDU indication signaling transmitted by a station device; and a determining module 420, configured to determine, based on the ELR PPDU indication signaling, whether to transmit and/or receive an ELR PPDU.

Through the ELR PPDU indication apparatus provided in this embodiment, the station device transmits, to the target terminal device, the ELR PPDU indication signaling that is used to indicate whether the target terminal device is to transmit and/or receive the ELR PPDU, so that the target terminal device in a dynamic state can activate or deactivate an ELR PPDU reception/transmission strategy in a timely manner to adapt to the dynamic change requirements for the terminal device. This method not only fills the gap in the current IEEE standard for an ELR PPDU indication, but also effectively mitigates the issues of resource waste or poor communication signal.

It should be understood that the apparatus 400 according to this embodiment of this application may correspond to the terminal device in the method embodiments of this application, and the above and other operations and/or functions of various units in the apparatus 400 are respectively intended to implement the corresponding flows of the station device in the method embodiments shown in FIGS. 2 to 5. For brevity, details are not described herein again.

An embodiment of this application provides a station device, including: a processor and a memory, where the memory is configured to store a computer program, and the processor is configured to invoke and run the computer program stored in the memory to execute the method applied to the station device in the embodiments of this application.

An embodiment of this application provides a terminal device, including: a processor and a memory, where the memory is configured to store a computer program, and the processor is configured to invoke and run the computer program stored in the memory to execute the method applied to the terminal device in the embodiments of this application.

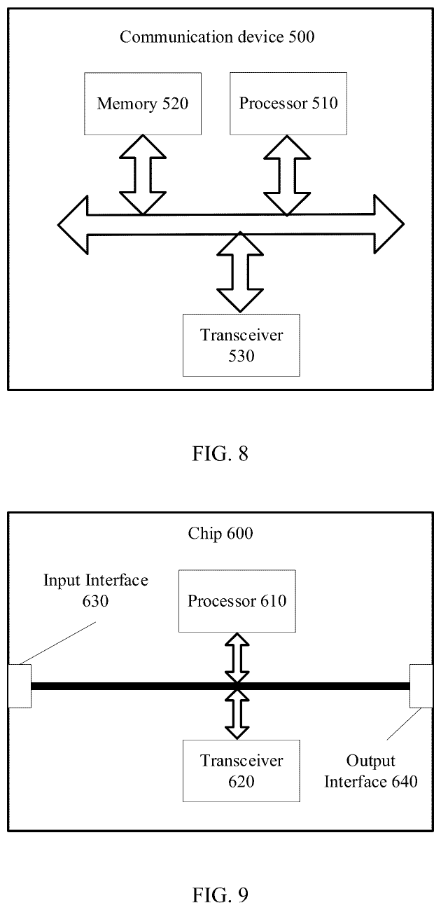

FIG. 8 is a schematic structural diagram of a communication device 500 according to an embodiment of this application. The communication device 500 shown in FIG. 8 includes a processor 510, and the processor 510 may invoke and run a computer program from a memory to execute the method in the embodiments of this application.

Optionally, as shown in FIG. 8, the communication device 500 may further include a memory 520. The processor 510 may invoke and run a computer program from the memory 520 to implement the method in the embodiments of this application. For example, when the communication device 500 is a station device, the processor 510 may invoke and run a computer program from the memory 520 to implement various steps of the method embodiments executed by the station device, with the same technical effects achieved. When the communication device 500 is a terminal device, the processor 510 may invoke and run a computer program from the memory 520 to implement various steps of the method embodiments executed by the terminal device, the same technical effects achieved.

Optionally, the memory 520 may be a separate device independent of the processor 510 or integrated in the processor 510.

Optionally, as shown in FIG. 8, the communication device 500 may further include a transceiver 530. The processor 510 may control the transceiver 530 to communicate with other devices. Specifically, the transceiver 530 may transmit information or data to other devices or receive information or data transmitted by other devices.

Optionally, the transceiver 530 may include a transmitter and a receiver. The transceiver 530 may further include an antenna. One or more antennas may be provided.

FIG. 9 is a schematic structural diagram of a chip according to an embodiment of this application. The chip 600 shown in FIG. 9 includes a processor 610, and the processor 610 may invoke and run a computer program from a memory to execute the method in the embodiments of this application.

Optionally, as shown in FIG. 9, the chip 600 may further include a memory 620. The processor 610 may invoke and run a computer program from the memory 620 to execute the method in the embodiments of this application.

Optionally, the memory 620 may be a separate device independent of the processor 610 or integrated in the processor 610.

Optionally, the chip 600 may further include an input interface 630. The processor 610 may control the input interface 630 to communicate with other devices or chips, for example, to obtain information or data transmitted by other devices or chips.

Optionally, the chip 600 may further include an output interface 640. The processor 610 may control the output interface 640 to communicate with other devices or chips, for example, to output information or data to other devices or chips.

Optionally, the chip may be applied to the station device in the embodiments of this application, and the chip may implement the corresponding flows implemented by the station device in various methods of the embodiments of this application. For brevity, details are not described herein again.

Optionally, the chip may be applied to the terminal device in the embodiments of this application, and the chip may implement the corresponding flows implemented by the terminal device in various methods of the embodiments of this application. For brevity, details are not described herein again.

It should be understood that the chip mentioned in the embodiments of this application may also be called a system-level chip, a system chip, a chip system, or a system-on-chip.

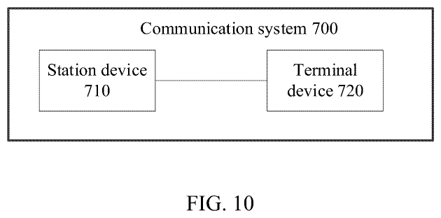

FIG. 10 is a schematic block diagram of a communication system 700 according to an embodiment of this application. As shown in FIG. 10, the communication system 700 includes a station device 710 and a terminal device 720.

The station device 710 may be configured to implement the corresponding functions implemented by the station device in the above method, and the terminal device 720 may be configured to implement the corresponding functions implemented by the terminal device in the above method. For brevity, details are not described herein again.

It should be understood that the processor in the embodiments of this application may be an integrated circuit chip with signal processing capability. In the implementation process, the steps of the above method embodiments may be completed by an integrated logic circuit of hardware in the processor or instructions in the form of software. The above processor may be a general-purpose processor, a digital signal processor (Digital Signal Processor, DSP), an application specific integrated circuit (Application Specific Integrated Circuit, ASIC), a field programmable gate array (Field Programmable Gate Array, FPGA) or other programmable logic devices, a discrete gate or transistor logic device, or a discrete hardware component. The process may implement or execute the methods, steps, and logic block diagrams disclosed in the embodiments of this application. The general-purpose processor may be a microprocessor or the processor may also be any conventional processor. The steps of the method disclosed in conjunction with the embodiments of this application may be directly executed by a hardware decoding processor or executed by a combination of hardware and software modules in the decoding processor. The software module may be located in a random access memory, a flash memory, a read-only memory, a programmable read-only memory, or an electrically erasable programmable memory, a register, and other mature storage media in the field. The storage medium is located in the memory. The processor reads the information in the memory and completes the steps of the above method in combination with its hardware.

It may be understood that the memory in the embodiments of this application may be a volatile memory or a non-volatile memory, or may include both volatile and non-volatile memories. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), which is used as an external cache. Through illustrative but non-limiting description, many forms of RAMs may be used, such as a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synchlink DRAM, SLDRAM), and a direct memory bus random access memory (Direct Rambus RAM, DR RAM). It should be noted that the memories described in the system and method of this specification are intended to include, but not limited to, these and any other suitable types of memories.

It should be understood that the above memory is exemplary but not restrictive. For example, the memory in the embodiments of this application may alternatively be a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchronous link dynamic random access memory (synchlink DRAM, SLDRAM), a direct memory bus random access memory (Direct Rambus RAM, DR RAM), or the like. That is, the memories in the embodiments of this application are intended to include, but not limited to, these and any other suitable types of memories.

An embodiment of this application further provides a readable storage medium, where a computer program is stored on the readable storage medium, and when the computer program is executed by a processor, various processes of the above method embodiments are implemented.

Optionally, the readable storage medium may be applied to the access point device in the embodiments of this application, and the computer program enables the processor to execute the corresponding flows implemented by the access point device in the method embodiments of this application. To avoid repetition, details are not described herein again.

Optionally, the readable storage medium may be applied to the station device in the embodiments of this application, and the computer program enables the processor to execute the corresponding flows implemented by the station device in the method embodiments of this application. To avoid repetition, details are not described herein again.

An embodiment of this application further provides a computer program product, including a computer program, where when the computer program is executed by a processor, various processes of the above method embodiments are implemented.

Optionally, the computer program product may be applied to the access point device in the embodiments of this application, and the computer program enables the processor to execute the corresponding flows implemented by the access point device in the method embodiments of this application. To avoid repetition, details are not described herein again.

Optionally, the computer program product may be applied to the station device in the embodiments of this application, and the computer program enables the processor to execute the corresponding flows implemented by the station device in the method embodiments of this application. To avoid repetition, details are not described herein again.

An embodiment of this application further provides a computer program. When the computer program is executed by a processor, various processes of the above method embodiments are implemented.

Optionally, the computer program may be applied to the access point device in the embodiments of this application, and the computer program enables the processor to execute the corresponding flows implemented by the access point device in the method embodiments of this application. To avoid repetition, details are not described herein again.

Optionally, the computer program may be applied to the station device in the embodiments of this application, and the computer program enables the processor to execute the corresponding flows implemented by the station device in the method embodiments of this application. To avoid repetition, details are not described herein again.

Those of ordinary skill in the art may realize that units and algorithm steps of various examples described with reference to the embodiments disclosed in this specification can be implemented by using electronic hardware or a combination of computer software and electronic hardware. Whether the functions are performed by hardware or software depends on particular applications and design constraints of the technical solutions. Those skilled in the art may employ a different method to implement the described functions for each particular application, but such implementations shall not be construed as going beyond the scope of this application.

It may be clearly understood by those skilled in the art that, for the purpose of convenient and brief description, for a detailed working process of the foregoing system, apparatus, and unit, reference may be made to a corresponding process in the foregoing method embodiments, and details are not described herein again.

For the several embodiments provided in this application, it should be understood that the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings, direct couplings or communication connections may be indirect couplings or communication connections through some interfaces, apparatuses or units, and may be in electrical, mechanical, or other forms.

The units described as separate parts may or may not be physically separate. Components displayed as units may or may not be physical units, that is, they may be located at one position or may be distributed on a plurality of network units. Some or all of the units may be selected depending on actual requirements to achieve the objectives of the solutions of the embodiments.

In addition, the functional units in the embodiments of this application may be integrated into one processing unit, or each of the units may exist alone physically, or two or more units may be integrated into one unit.

When realized in form of a software functional unit and sold or used as an independent product, the function may also be stored in a computer-readable storage medium. Based on such an understanding, the technical solutions in the embodiments of this application essentially, or the part contributing to the prior art, or some of the technical solutions may be implemented in a form of a software product. The computer software product is stored in a storage medium and includes several instructions for instructing a computer device (which may be a personal computer, a server, a network device, or the like) to perform all or some of the steps of the method described in the embodiments of this application. The foregoing storage medium includes various media capable of storing program code, such as a USB flash drive, a removable hard disk, a read-only memory (Read-Only Memory, ROM), a random access memory (Random Access Memory, RAM), a magnetic disk, or an optical disc.

The foregoing descriptions are merely specific embodiments of this application, but the protection scope of this application is not limited thereto. Any variations or replacements apparent to those skilled in the art within the technical scope disclosed in this application should be included within the disclosure scope of this application. Therefore, the protection scope of this application should be subject to the protection scope of the claims.

What is claimed is:

1. An Enhanced Long Range Physical Layer Protocol Data Unit (ELR PPDU) indication method, comprising:
transmitting ELR PPDU indication signaling to a target terminal device, wherein the ELR PPDU indication signaling is configured to indicate whether the target terminal device is to transmit and/or receive an ELR PPDU;
wherein the ELR PPDU indication signaling is configured to indicate the target terminal device to enable or disable an ELR PPDU transmission and/or reception function;
wherein the ELR PPDU indication signaling is carried in a Multi-User Physical Layer Protocol Data Unit (MU PPDU) frame for transmission.

2. The method according to claim 1, wherein the ELR PPDU indication signaling is configured to indicate the target terminal device to transmit and/or receive the ELR PPDU based on configuration information in the ELR PPDU indication signaling.

3. The method according to claim 2, wherein the configuration information comprises one or more of an ELR PPDU transmission bandwidth, an uplink/downlink indication, the number of transmission streams, transmission duration, transmit power, transmission Modulation and Coding Scheme (MCS), or a frame structure.

4. The method according to claim 1, wherein the ELR PPDU indication signaling is implemented by configuring a value of a PPDU Type And Compression Mode field and a value of a UL/DL field in the MU PPDU frame.

5. The method according to claim 4, wherein when the ELR PPDU indication signaling is used to indicate the target terminal device to enable the ELR PPDU transmission and/or reception function, the value of the PPDU Type And Compression Mode field and the value of the UL/DL field satisfy one of the following:
DL=0, PPDU Type And Compression Mode=3; or
UL=1, PPDU Type And Compression Mode=3.

6. The method according to claim 5, wherein all other values of the PPDU Type And Compression Mode field and the UL/DL field all indicate that the ELR PPDU indication signaling is configured to indicate the target terminal device to disable the ELR PPDU.

7. The method according to claim 1, wherein the ELR PPDU indication signaling is carried in a U-SIG field in the MU PPDU frame for transmission.

8. The method according to claim 7, wherein the U-SIG field further comprises a U-SIG-2 field, the ELR PPDU indication signaling is carried in the U-SIG-2 field.

9. The method according to claim 7, wherein the ELR PPDU indication signaling is implemented by configuring a modulation scheme of at least one Orthogonal Frequency Division Multiplexing (OFDM) symbol in the U-SIG field.

10. The method according to claim 9, wherein when the ELR PPDU indication signaling is used to indicate the target terminal device to enable the ELR PPDU transmission and/or reception function, a modulation scheme of a second OFDM symbol in the U-SIG field is QBPSK.

11. An Enhanced Long Range Physical Layer Protocol Data Unit (ELR PPDU) indication method, comprising:
receiving ELR PPDU indication signaling transmitted by a station device; and
determining, based on the ELR PPDU indication signaling, whether to transmit and/or receive an ELR PPDU; wherein the determining, based on the ELR PPDU indication signaling, whether to transmit and/or receive an ELR PPDU comprises:
determining, based on the ELR PPDU indication signaling, to enable or disable an ELR PPDU transmission and/or reception function; wherein the ELR PPDU indication signaling is carried in a Multi-User Physical Layer Protocol Data Unit (MU PPDU) frame for transmission.

12. The method according to claim 11, wherein the ELR PPDU indication signaling is implemented by configuring a value of a PPDU Type And Compression Mode field and a value of a UL/DL field in the MU PPDU frame.

13. The method according to claim 12, wherein the value of the PPDU Type And Compression Mode field and the value of the UL/DL field satisfy one of the following:
DL=0, PPDU Type And Compression Mode=3; or
UL=1, PPDU Type And Compression Mode=3.
